(19) United States
(12) Patent Application Publication
(10) Pub. No.: US 2017/0002261 A1
(43) Pub. Date: Jan. 5, 2017

(54) LOW MOLECULAR WEIGHT GUAR AS GELLING AGENT ADDITIVE

(71) Applicant: Schlumberger Technology Corporation, Sugar Land, TX (US)

(72) Inventors: Andrey Mirakyan, Katy, TX (US); Derek Brown, Houston, TX (US); Richa Sethi, Richmond, TX (US); Blake McMahon, Sugar Land, TX (US); Bruce MacKay, Sugar Land, TX (US); Dominic Perroni, Sugar Land, TX (US)

(21) Appl. No.: 15/200,185

(22) Filed: Jul. 1, 2016

Related U.S. Application Data
(60) Provisional application No. 62/187,275, filed on Jul. 1, 2015.

(51) Int. Cl. C09K 8/68; C09K 8/575; C09K 8/90

(52) U.S. Cl. CPC C09K 8/68; C09K 8/905; C09K 8/5758

(57) ABSTRACT

A composition or compositions useful as a well treatment fluid is disclosed containing high molecular weight guar and low molecular weight water soluble polymer having a lower molecular weight than the high molecular weight guar. The composition can also contain water and a crosslinking agent, and the low molecular weight water soluble polymer can include a low molecular weight guar. A method of treating a subterranean formation is also disclosed including placing the composition(s) in the subterranean formation.

### CROSS REFERENCE

The present application claims the benefit of U.S. Patent Provisional Application No. 62/187,275, entitled “Low Molecular Weight Guar as Gelling Agent Additive”, filed Jul. 1, 2015, which is incorporated herein by reference in its entirety.

### FIELD

The disclosure generally relates to methods and compositions for treating a subterranean formation, and more particularly, but not by way of limitation, treating a subterranean formation with a composition containing high molecular weight guar and low molecular weight water soluble polymer.

### BACKGROUND

Hydrocarbons (oil, natural gas, etc.) may be obtained from a subterranean geologic formation (a “reservoir”) by drilling a well that penetrates the hydrocarbon-bearing formation. Well treatment methods often are used to increase hydrocarbon production by using a treatment fluid to interact with a subterranean formation in a manner that ultimately increases oil or gas flow from the formation to the wellbore for removal to the surface.

Well treatment fluids, particularly those used in fracturing (fracturing fluids) or those used in gravel packing operations (gravel packing fluids), may comprise a water or oil based fluid incorporating a thickening agent, normally a polymeric material. Such polymeric thickening agents can also include crosslinkable components. Polymeric thickening agents for use in such fluids may comprise galactomannan gums, such as guar and substituted guars such as hydroxypropyl guar and carboxymethylhydroxypropyl guar (CMHPG). Cellulosic polymers such as carboxymethyl cellulose (CMC) may also be used, as well as synthetic polymers such as polyacrylamide. Such fracturing fluids can have a high viscosity during a treatment to develop a desired fracture geometry and/or to carry proppant into a fracture with sufficient resistance to settling. These fluids can also develop a filter cake which includes the polymeric additives. Guar gum (galactomannan) is the most commonly used gelling agent in the oilfield services industry. Typical regular guar gum (RGG) contains one galactose per two mannose units and has average molecular weight of about 2 min. Lower molecular weight guar gum (LMWGG), with Mw less than 500K, can be generated as a byproduct/waste stream during the production and purification of RGG. LMWGG has much lower viscosity yield per pound of dry polymer and lower thermal stability of borate cross-linked gels and therefore is not considered a good candidate for oilfield applications, even given its much reduced cost as compared to RGG. However, there is always a desire in the oilfield services industry to reduce the cost of the treatment fluids employed without significantly reducing the effectiveness of such.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect of the disclosure, compositions are provided which include a high molecular weight guar and low molecular weight water soluble polymer having a lower molecular weight than the high molecular weight guar.

In one aspect of the disclosure, methods of treating a subterranean formation are provided which include:

a) providing a composition including water, a crosslinking agent, high molecular weight guar, and low molecular weight water soluble polymer having a lower molecular weight than the high molecular weight guar; and
b) placing the composition into the subterranean formation.

### BRIEF DESCRIPTION OF DRAWINGS

The manner in which the objectives of the present disclosure and other desirable characteristics may be obtained is explained in the following description and attached drawings in which:

FIG. 1 is an illustration of the rheology profile of the fluids of Example 1.

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The statements made herein merely provide information related to the present disclosure and may not constitute prior art, and may describe some embodiments illustrating aspects of the invention.

Disclosed herein are composition(s) and method(s) of treating a subterranean formation using such composition(s).

The compostion(s) can comprise, consist of, or consist essentially of high molecular weight guar and low molecular weight water soluble polymer having a lower molecular weight than the high molecular weight guar. The low molecular weight water soluble polymer can comprise, consist of, or consist essentially of a low molecular weight guar. The low molecular weight guar can be generated as a by-product during the production and purification of high molecular weight guar.

The high molecular weight guar can have a molecular weight greater than about 1,000,000 or greater than 1,500,000 or greater than about 2,000,000; and the low molecular weight water soluble polymer can have a molecular weight less than about 500,000 or less than about 600,000 or less than about 800,000.

The low molecular weight water soluble polymer can be present in the composition(s) described herein in an amount greater than or equal to about 0.01 or 1, or 2, or 3, or 4, or 5, or 6, or 7, or 8, or 9, or 10, or 15 wt %, and less than or equal to about 50 or 45 or 40 or 35 or 30 or 25 or 20 wt %, based on the total weight of the composition(s). The high molecular weight guar can be present in the composition(s) described herein in an amount greater than or equal to about 0.01 or 1, or 2, or 3, or 4, or 5, or 6, or 7, or 8, or 9, or 10, or 15 wt %, and less than or equal to about 50 or 45 or 40 or 35 or 30 or 25 or 20 wt %, based on the total weight of the composition(s).

The composition(s) described herein can further comprise, consist of, or consist essentially of water and a crosslinking agent, in addition to the high molecular weight guar and the low molecular weight water soluble polymer described herein. The water can be present in the composition(s) in an amount greater than or equal to about 90 wt % or about 92 wt % or about 95 wt %, and less than or equal to about 99.9 wt % or about 98 wt % or about 97 wt %, based on the total weight of the composition(s). The crosslinking agent is present in an amount greater than or equal to about 5 ppm or about 50 ppm or about 100 ppm and less than or equal to about 2000 ppm, based on the total weight of the composition(s).

The crosslinking agent can be any crosslinker effective for crosslinking crosslinkable polymer compounds, and can comprise, consist of, or consist essentially of a component selected from the group consisting of zirconium, titanium, aluminum, a borate compound, and combinations thereof. Borate compounds can include boric acid and salts, or any other Boron-containing chemical capable of generating borate anion(s) under basic conditions.

The viscosity of the composition(s) described herein can be stable over an extended period of time, such as for at least 30 minutes, or for at least 1 hour, or for at least 2 hours, at the temperatures described herein of about 100° F. to about 280° F.

A method or methods of treating a subterranean formation is also disclosed, the method(s) comprising, consisting of, or consisting essentially of:
a) providing the composition(s) described herein comprising, consisting of, or consisting essentially of water, the crosslinking agent as described herein, the high molecular weight guar as described herein, and the low molecular weight water soluble polymer as described herein having a lower molecular weight than the high molecular weight guar; and
b) placing the composition(s) into the subterranean formation.

The temperature of the composition(s) in the subterranean formation can be in the range of from about 100° F. to about 280° F., or from about 120° F. to about 200° F., or from about 130° F. to about 180° F.

Additional Materials

While the composition(s) of the present disclosure are described herein as comprising the above-mentioned components, it should be understood that the composition(s) of the present disclosure may optionally comprise other chemically different materials. In embodiments, the composition(s) of the present disclosure may further comprise stabilizing agents, surfactants, diverting agents, or other additives. Additionally, the composition(s) may comprise a mixture of various crosslinking agents, and/or other additives, such as fibers or fillers, provided that the other components chosen for the mixture are compatible with the intended application. In embodiments, the composition(s) of the present disclosure may further comprise one or more components selected from the group consisting of a conventional gel breaker, a buffer, a proppant, a clay stabilizer, a gel stabilizer, a surfactant and a bactericide. Furthermore, the composition(s) may comprise buffers, pH control agents, and various other additives added to promote the stability or the functionality of the fluid composition(s). The components of the composition(s) may be selected such that they may or may not react with the subterranean formation that is to be treated.

In this regard, the composition(s) may include components independently selected from any solids, liquids, gases, and combinations thereof, such as slurries, gas-saturated or non-gas-saturated liquids, mixtures of two or more miscible or immiscible liquids, and the like, as long as such additional components allow for the breakdown of the three dimensional structure upon substantial completion of the treatment. For example, the composition(s) may comprise organic chemicals, inorganic chemicals, and any combinations thereof. Organic chemicals may be monomeric, oligomeric, polymeric, crosslinked, and combinations, while polymers may be thermoplastic, thermosetting, moisture setting, elastomeric, and the like. Inorganic chemicals may be metals, alkaline and alkaline earth chemicals, minerals, and the like. Fibrous materials may also be included in the crosslinkable fluid or treatment fluid. Suitable fibrous materials may be woven or nonwoven, and may be comprised of organic fibers, inorganic fibers, mixtures thereof and combinations thereof.

Stabilizing agents can be added to slow the degradation of the crosslinked structure of the viscosified composition(s) after its formation downhole. Stabilizing agents may include buffering agents, such as agents capable of buffering at pH of about 8.0 or greater (such as water-soluble bicarbonate salts, carbonate salts, phosphate salts, or mixtures thereof, among others); polyols such as sorbitol or sodium gluconate, and chelating agents (such as ethylenediaminetetraacetic acid (EDTA), nitrilotriacetic acid (NTA), or diethylenetriaminepentaacetic acid (DTPA), hydroxyethylethylenediaminetriacetic acid (HEDTA), or hydroxyethyliminodiacetic acid (HEIDA), among others), which may or may not be the same as used for the coordinated ligand system of the chelated metal. Buffering agents may be added to the composition(s) in an amount from about 0.05 wt % to about 10 wt %, and from about 0.1 wt % to about 2 wt %, based upon the total weight of the composition(s). Chelating agents may also be added to the composition(s).

The aqueous based composition(s) of the present application may generally comprise fresh water, salt water, sea water, a brine (e.g., a saturated salt water or formation brine), or a combination thereof. Other water sources may be used, including those comprising monovalent, divalent, or trivalent cations (e.g., magnesium, calcium, zinc, or iron) and, where used, may be of any weight.

Chelation is the formation or presence of two or more separate bindings between a multiple-bonded ligand and a single central atom. These ligands may be organic compounds, and are called chelating agents, chelants, or chelators. A chelating agent forms complex molecules with certain metal ions, inactivating the ions so that they cannot normally react with other elements or ions to produce precipitates or scale. Examples of chelating agents include nitrilotriacetic acid (NTA); citric acid; ascorbic acid; hydroxyethylethylenediaminetriacetic acid (HEDTA) and its salts, including sodium, potassium, and ammonium salts; ethylenediaminetetraacetic acid (EDTA) and its salts, including sodium, potassium, and ammonium salts; diethylenetriaminepentaacetic acid (DTPA) and its salts, including sodium, potassium, and ammonium salts; phosphinopolyacrylate; thioglycolates; and a combination thereof. Other chelating agent are: aminopolycarboxylic acids and phosphonic acids and sodium, potassium and ammonium salts thereof; HEIDA (hydroxyethyliminodiacetic acid); other aminopolycarboxylic acid members, including EDTA and NTA (nitrilotriacetic acid), but also: DTPA (diethylenetriamine-pentaacetic acid), and CDTA (cyclohexylenediamintetraacetic acid) are also suitable; phosphonic acids and their salts, including ATMP (aminotri-(methylenephosphonic acid)), HEDP (1-hydroxyethylidene-1,1-phosphonic acid), HDTMPA (hexamethylenediaminetetra-(methylenephosphonic acid)), DTPMPA (diethylenediaminepenta-(methylenephosphonic acid)), and 2-phosphonobutane-1,2,4-tricarboxylic acid.

Aqueous composition embodiments may also comprise an organoamino compound. Examples of suitable organoamino compounds may include tetraethylenepentamine (TEPA), triethylenetetramine, pentaethylenehexamine, triethanolamine, and the like, or any mixtures thereof. When organoamino compounds are used in composition(s) described herein, they are incorporated at an amount from about 0.01 wt % to about 2.0 wt % based on total liquid phase weight. The organoamino compound may be incorporated in an amount from about 0.05 wt % to about 1.0 wt % based on total weight of the composition(s).

Thermal stabilizers may also be included in the composition(s). Examples of thermal stabilizers include, for example, methanol, alkali metal thiosulfate, such as sodium thiosulfate, ammonium thiosulfate and ascorbic acid or its sodium salt. The concentration of thermal stabilizer in the composition(s) may be from about 0.1 to about 5 weight %, from about 0.2 to about 2 weight %, from about 0.2 to about 1 weight %, from about 0.5 to about 1 weight % of the thermal stabilizers based on the total weight of the composition(s).

One or more clay stabilizers may also be included in the composition(s). Suitable examples include hydrochloric acid and chloride salts, such as, choline chloride, tetramethylammonium chloride (TMAC) or potassium chloride. Aqueous solutions comprising clay stabilizers may comprise, for example, 0.05 to 0.5 weight % of the stabilizer, based on the combined weight of the aqueous liquid and the organic polymer (i.e., the base gel). Surfactants can be added to promote dispersion or emulsification of components of the composition(s), or to provide foaming of the crosslinked component upon its formation downhole. Suitable surfactants include alkyl polyethylene oxide sulfates, alkyl alkylolamine sulfates, modified ether alcohol sulfate sodium salts, or sodium lauryl sulfate, among others. Any surfactant which aids the dispersion and/or stabilization of a gas component in the fluid to form an energized fluid can be used. Viscoelastic surfactants, such as those described in U.S. Pat. Nos. 6,703,352; 6,239,183; 6,506,710; 7,303,018 and 6,482,866, the disclosures of which are incorporated herein by reference in their entireties, are also suitable for use in fluids in some embodiments. Examples of suitable surfactants also include, but are not limited to, amphoteric surfactants or zwitterionic surfactants. Alkyl betaines, alkyl amido betaines, alkyl imidazolines, alkyl amine oxides and alkyl quaternary ammonium carboxylates are some examples of zwitterionic surfactants. An example of a useful surfactant is the amphoteric alkyl amine contained in the surfactant solution AQUAT 944® (available from Baker Petrolite of Sugar Land, Tex.). A surfactant may be added to the crosslinkable fluid in an amount in the range of about 0.01 wt % to about 10 wt %, such as about 0.1 wt % to about 2 wt %.

Charge screening surfactants may be employed. In some embodiments, the anionic surfactants such as alkyl carboxylates, alkyl ether carboxylates, alkyl sulfates, alkyl ether sulfates, alkyl sulfonates, α-olefin sulfonates, alkyl ether sulfates, alkyl phosphates and alkyl ether phosphates may be used. Anionic surfactants have a negatively charged moiety and a hydrophobic or aliphatic tail, and can be used to charge screen cationic polymers. Examples of suitable ionic surfactants also include, but are not limited to, cationic surfactants such as alkyl amines, alkyl diamines, alkyl ether amines, alkyl quaternary ammonium, dialkyl quaternary ammonium and ester quaternary ammonium compounds. Cationic surfactants have a positively charged moiety and a hydrophobic or aliphatic tail, and can be used to charge screen anionic polymers such as CMHPG.

In other embodiments, the surfactant is a blend of two or more of the surfactants described above, or a blend of any of the surfactant or surfactants described above with one or more nonionic surfactants. Examples of suitable nonionic surfactants include, but are not limited to, alkyl alcohol ethoxylates, alkyl phenol ethoxylates, alkyl acid ethoxylates, alkyl amine ethoxylates, sorbitan alkanoates and ethoxylated sorbitan alkanoates. Any effective amount of surfactant or blend of surfactants may be used in aqueous energized fluids.

Friction reducers may also be incorporated in any fluid embodiment. Any suitable friction reducer polymer, such as polyacrylamide and copolymers, partially hydrolyzed polyacrylamide, poly(2-acrylamido-2-methyl-propane sulfonic acid) (polyAMPS), and polyethylene oxide may be used. Commercial drag reducing chemicals such as those sold by Conoco Inc. under the trademark “CDR” as described in U.S. Pat. No. 3,692,676 or drag reducers such as those sold by Chemlink designated under the trademarks FLO1003, FLO1004, FLO1005 and FLO1008 have also been found to be effective. These polymeric species added as friction reducers or viscosity index improvers may also act as excellent fluid loss additives reducing the use of conventional fluid loss additives. Latex resins or polymer emulsions may be incorporated as fluid loss additives. Shear recovery agents may also be used in embodiments.

Diverting agents may be added to improve penetration of the composition(s) into lower-permeability areas when treating a zone with heterogeneous permeability. The use of diverting agents in formation treatment applications is known, such as given in Reservoir Stimulation, 3^{rd} edition, M. Economides and K. Nolte, eds., Section 19.3.

Embodiments may also include proppant particles that are substantially insoluble in the fluids of the formation. Proppant particles carried by the composition(s) remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it may be from about 12 to about 150 U.S. Standard Mesh in size. With synthetic proppants, mesh sizes about 8 or greater may be used. Naturally occurring materials may be underived and/or unprocessed naturally occurring materials, as well as materials based on naturally occurring materials that have been processed and/or derived. Suitable examples of naturally occurring particulate materials for use as proppants include: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particulation, processing, etc.

The concentration of proppant in the composition(s) can be any concentration known in the art. For example, the concentration of proppant in the composition(s) may be in the range of from about 0.03 to about 3 kilograms of proppant added per liter of liquid phase. Also, any of the proppant particles can further be coated with a resin to potentially improve the strength, clustering ability, and flow back properties of the proppant.

Embodiments may further use composition(s) containing other additives and chemicals that are known to be commonly used in oilfield applications by those skilled in the art. These include materials such as surfactants in addition to those mentioned hereinabove, breaker activators (breaker aids) in addition to those mentioned hereinabove, oxygen scavengers, alcohol stabilizers, scale inhibitors, corrosion inhibitors, fluid-loss additives, bactericides and biocides such as 2,2-dibromo-3-nitrilopropionamine or glutaraldehyde, and the like. Also, they may include a co-surfactant to optimize viscosity or to minimize the formation of stable emulsions that contain components of crude oil.

In embodiments, the composition(s) may be driven into a wellbore by a pumping system that pumps one or more treatment fluids into the wellbore. The pumping systems may include mixing or combining devices, wherein various components, such as fluids, solids, and/or gases may be mixed or combined prior to being pumped into the wellbore. The mixing or combining device may be controlled in a number of ways, including, but not limited to, using data obtained either downhole from the wellbore, surface data, or some combination thereof.

The foregoing is further illustrated by reference to the following examples, which are presented for purposes of illustration and are not intended to limit the scope of the present disclosure.

### Examples

The fluids in this example were prepared using tap water. For each of the fluids, dry guar gelling agent containing varying amounts of high molecular weight guar (HWG) and low molecular weight guar (LWG) was added to water at 0.25% by weight and hydrated in a Warring blender for 30 mins at ambient temperature to form a hydrated polymer solution:

A—Baseline—the dry guar contained 100 wt % HWG;
B—20% LWG—the dry guar contained 80 wt % HWG and 20 wt % LWG;
C—30% LWG—the dry guar contained 70 wt % HWG and 30 wt % LWG;
D—40% LWG—the dry guar contained 60 wt % HWG and 40 wt % LWG.

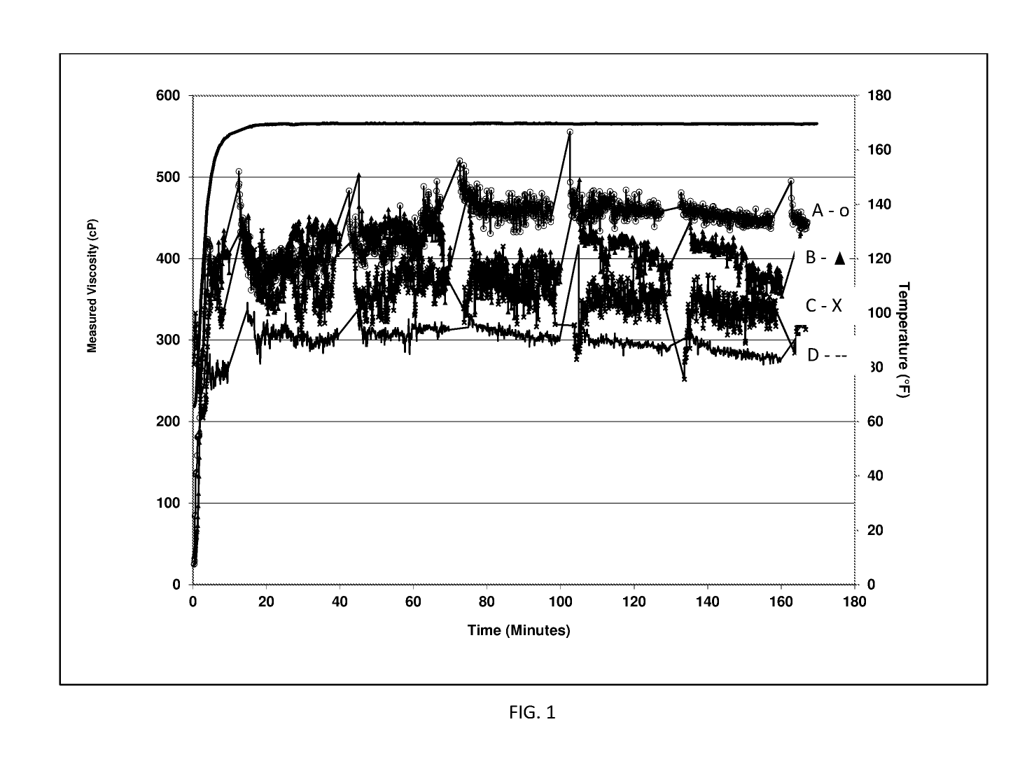

For each of the fluids, a borate crosslinker in amount corresponding to 60 ppm of Boron was added to the hydrated polymer solution and pH was adjusted to 11 using an NaOH solution. Resulting crosslinked gels A-D were run at 100 s-1, 170 F and 500 psi on a Chandler5550 HP rheometer using RIBS cup/bob setup. The produced rheology curves are present in FIG. 1, and show that the crosslinked gels B-D containing low molecular weight guar (20 wt %, 30 wt % and 40 wt %) had similar stability over time as compared to the stability of the crosslinked gel A (baseline) containing 100 wt % HWG and 0 wt % LWG.

Although the preceding description has been described herein with reference to particular means, materials and embodiments, it is not intended to be limited to the particulars disclosed herein; rather, it extends to all functionally equivalent structures, methods and uses, such as are within the scope of the appended claims. Furthermore, although only a few example embodiments have been described in detail above, those skilled in the art will readily appreciate that many modifications are possible in the example embodiments without materially departing from this disclosure. Accordingly, all such modifications are intended to be included within the scope of this disclosure as defined in the following claims.

What is claimed is:

1. A composition comprising high molecular weight guar and low molecular weight water soluble polymer having a lower molecular weight than the high molecular weight guar.

2. The composition of claim 1 wherein the low molecular weight water soluble polymer comprises a low molecular weight guar.

3. The composition of claim 1 wherein the high molecular weight guar has a molecular weight greater than about 1,000,000.

4. The composition of claim 1 wherein the low molecular weight water soluble polymer has a molecular weight less than about 500,000.

5. The composition of claim 1 wherein the low molecular weight water soluble polymer is generated as a by-product during the production and purification of high molecular weight guar.

6. The composition of claim 1 wherein the low molecular weight water soluble polymer is present in the composition in an amount greater than or equal to about 0.01 wt %, and less than or equal to about 50 wt %, based on the total weight of the composition.

7. The composition of claim 6 wherein the high molecular weight guar is present in the composition in an amount greater than or equal to about 0.01 wt %, and less than or equal to about 50 wt %, based on the total weight of the composition.

8. The composition of claim 7 further comprising water and a crosslinking agent, wherein the water is present in the composition in an amount greater than or equal to about 90 wt %, and less than or equal to about 99.9 wt %, based on the total weight of the composition; and wherein the crosslinking agent is present in the composition in an amount greater than or equal to about 5 ppm, and less than or equal to about 2000 ppm, based on the total weight of the composition.

9. The composition of claim 8 wherein the viscosity of the composition is stable for at least 2 hours.

10. A method for treating a subterranean formation, the method comprising:
a) providing a composition comprising water, a crosslinking agent, high molecular weight guar, and low molecular weight water soluble polymer having a lower molecular weight than the high molecular weight guar; and
b) placing the composition into the subterranean formation.

11. The method of claim 10 wherein the low molecular weight water soluble polymer comprises a low molecular weight guar.

12. The method of claim 10 wherein the high molecular weight guar has a molecular weight greater than about 1,000,000, and the low molecular weight water soluble polymer has a molecular weight less than about 500,000.

13. The method of claim 10 wherein the low molecular weight water soluble polymer is generated as a by-product during the production and purification of high molecular weight guar.

14. The method of claim 10 wherein the low molecular weight water soluble polymer is present in the composition in an amount greater than or equal to about 0.01 wt %, and less than or equal to about 50 wt %, based on the total weight of the composition.

15. The method of claim 14 wherein the high molecular weight guar is present in the composition in an amount greater than or equal to about 0.01 wt %, and less than or equal to about 50 wt %, based on the total weight of the composition.

16. The method of claim 15 wherein the water is present in the composition in an amount greater than or equal to about 90 wt %, and less than or equal to about 99.9 wt %, based on the total weight of the composition, and wherein the crosslinking agent is present in the composition in an amount greater than or equal to about 5 ppm, and less than or equal to about 2000 ppm, based on the total weight of the composition.

17. The method of claim 10 wherein the temperature of the composition in the subterranean formation is in the range of from about 100° F. to about 280° F.

18. The method of claim 10 wherein the crosslinking agent comprises a component selected from the group consisting of zirconium, titanium, aluminum, a borate, and combinations thereof.
